(19) United States
(12) Patent Application Publication
(10) Pub. No.: US 2002/0092243 A1
(43) Pub. Date: Jul. 18, 2002

(54) Window regulator assembly

(76) Inventors: Klaus Maass, Istenbuttel (DE); Jurgen Moscr, Meine (DE)

Correspondence Address: Anthony P. Cho, CARLSON, GASKEY & OLDS, P.C., 400 West Maple Road, Suite 350, Birmingham, MI, 48009, US

(21) Appl. No.: 10/023,444

(22) Filed: Dec. 13, 2001

(30) Foreign Application Priority Data
Dec. 14, 2000 (GB) GB 0030532.6

(51) Int. Cl. E06B 3/00

(52) U.S. Cl. 49/501

(57) ABSTRACT

A window regulator assembly for assembly into a vehicle including a carrier having a first and second guide rail in a spaced generally parallel relationship, first and second upper cable guides being mounted on the carrier proximate the upper ends of the first and second guide rails respectively, first and second lower cable guides being mounted on the carrier proximate the lower ends of the first and second guide rails respectively with a cable path being defined between the first upper, second upper, first lower and second lower cable guides by a bare cable arrangement, the cable path having at least a first portion connecting the first upper cable guide to the first lower guide, a second portion connecting the second upper guide to the second lower cable, and a first further portion connecting one of the first upper and lower cable guides to one of the second upper and lower cable guides, the bare cable arrangement being drivable in use by a drive means, with a first and second cursor being connected to the bare cable arrangement so as to provide a double lift bare cable window regulator assembly.

This application claims priority to United Kingdom (GB) Patent Application No. 0030532.6 filed on Dec. 14, 2000.

### BACKGROUND

The present invention relates to a window regulator assembly and in particular a window regulator assembly for use in a vehicle such as a car (automobile).

Known window regulators may be made using a variety of mechanisms.

One popular version uses a rail or rails, each of which is fitted with a pulley or other means of cable guidance at its extremities, and some means of attachment to the door. The form of the rail is defined such that a cursor or slider attached to the glass (and which travels with it) would guide the glass in the desired movement. Cables are fitted between some form of drive mechanism (typically a drum mounted to a motor or a manual handle and brake assembly) and the cursor. These cables pass around the cable guidance means and are attached to the cursor. Typically, the drive mechanism is fitted to some of support plate which is mounted on the door inner panel The drive forces applied as tensile loads to the cables are reacted as compressive loads via external sheaths or cable outers, which guide the cables between the drive mechanism and means and of cable guidance in the manner of a bowden cable. The cable outers typically rest in receptacles provided for the purpose in the support plate of the drive mechanism, and in the rail or the means of cable guidance. The cable outer may be provided with adapters to ensure a secure and functional assembly and support means. The kinematic chain so described may also include tensioning means to maintain cable tension to a desired minimum level. The tensioning means may be integrated into the adapters.

This type of window regulator is commonly known as a drum-and-cable type of regulator.

One known embodiment of the above type of window regulator has two generally parallel rails upon which the cursors are caused to travel simultaneously, and which by virtue of the separation between the rails, offers advantages in terms of guidance and support of the glass, particular in a pitching direction with regards to a side window of a vehicle.

This type of window regulator is commonly known as a double lift drum-and-cable type. In particular such known double lift drum-and-cable regulators all include cable outer (cable sheaths).

A further known embodiment of the above type of window regulator has only one rail, but by making a rigid mechanical connection between the mounting of the drive mechanism and the rail, this obviates the need for the cable outer, since the tensile forces in the cables are reacted through the mechanism itself, at least in part. Forces may also be reacted through the vehicle door or other surface to which the window regulator is mounted. This simplifies the assembly of the window regulator significantly and has attendant benefits of reduced costs and weight.

This type of window regulator is commonly known as a single lift bare cable regulator.

An object of the present invention is to provide an improved form of window regulator having improved glass stability and which is simpler to produce.

### SUMMARY OF THE INVENTION

According to the present invention, there is provided a window regulator assembly for assembly into a vehicle including a carrier having a first and second guide rail in a spaced generally parallel relationship, first and second upper cable guides being mounted on the carrier proximate the upper ends of the first and second guide rails respectively, first and second lower cable guides being mounted on the carrier proximate the lower ends of the first and second guide rails respectively with a cable path being defined between the first upper, second upper, first lower and second lower cable guides by a bare cable arrangement, the cable path having at least a first portion connecting the first upper cable guide to the first lower guide, a second portion connecting the second upper guide to the second lower cable, and a first further portion connecting one of the first upper and lower cable guides to one of the second upper and lower cable guides, the bare cable arrangement being drivable in use by a drive means, with a first and second cursor being connected to the bare cable arrangement so as to provide a double lift bare cable window regulator assembly.

Advantageously, the carrier ensures that the cable path remains essentially the same length whether the window regulator is assembled to the door or not. Furthermore the carrier also provide support means for any tensioning device necessary to ensure the minimum cable tension is maintained despite the effects of manufacturing tolerances or service wear or stretching of the cable through use.

Support structure of the drive mechanism may be so designed to carry a seal, which in an appropriately designed door or quarter panel and when coupled with a suitably sealed drive mechanism, may obviate the need for further means of water management i.e. sealing between an inner cavity of the door and the associated vehicle.

### BRIEF DESCRIPTION OF THE DRAWINGS

The invention will now be described, by way of example only, with reference to the accompanying drawings in which:

FIG. 1 is an exploded view of a door including a window regulator according to the present invention,

FIG. 2 is an exploded view of the window regulator of FIG. 1,

FIGS. 3 to 6 show the way in which the door of FIG. 1 is assembled and

FIG. 7 shows a further embodiment of a door.

### DETAILED DESCRIPTION OF THE PREFERRED EMBODIMENT

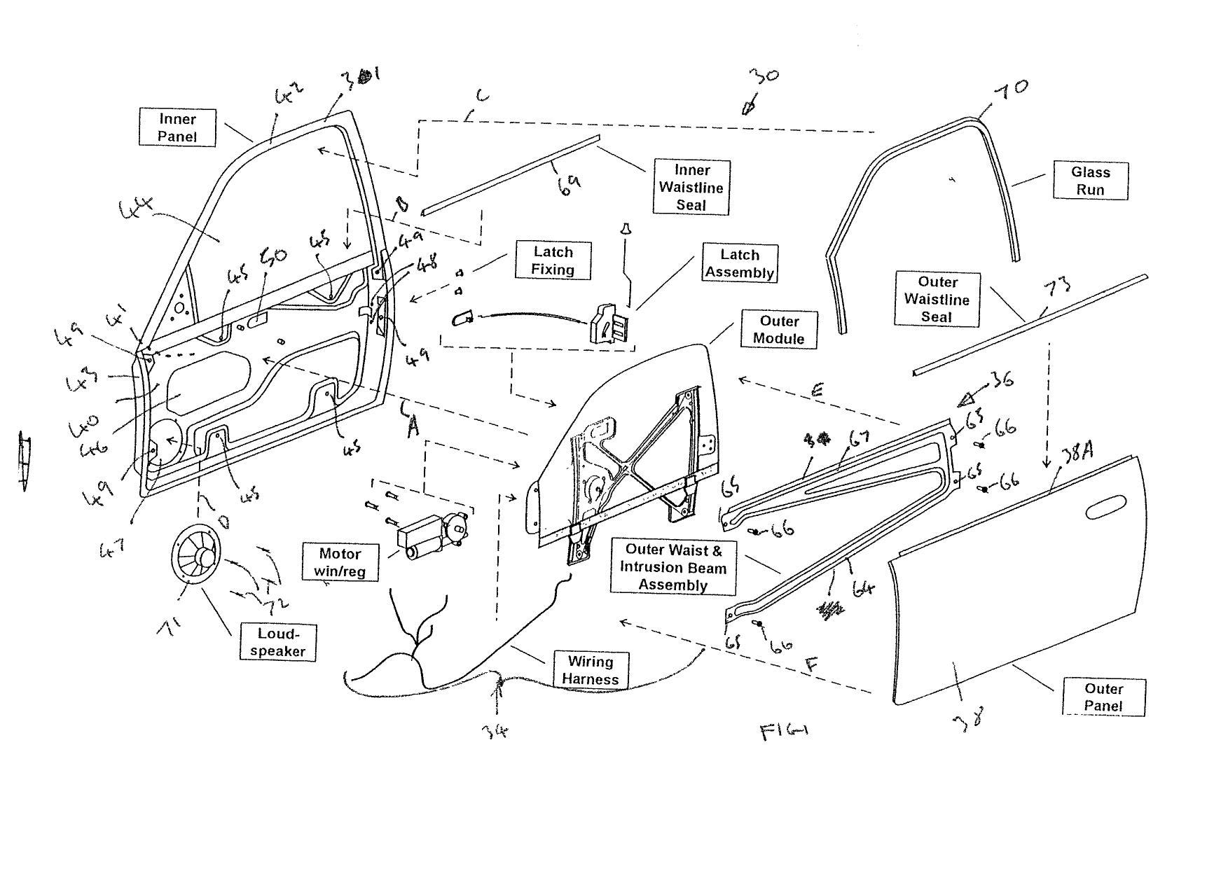

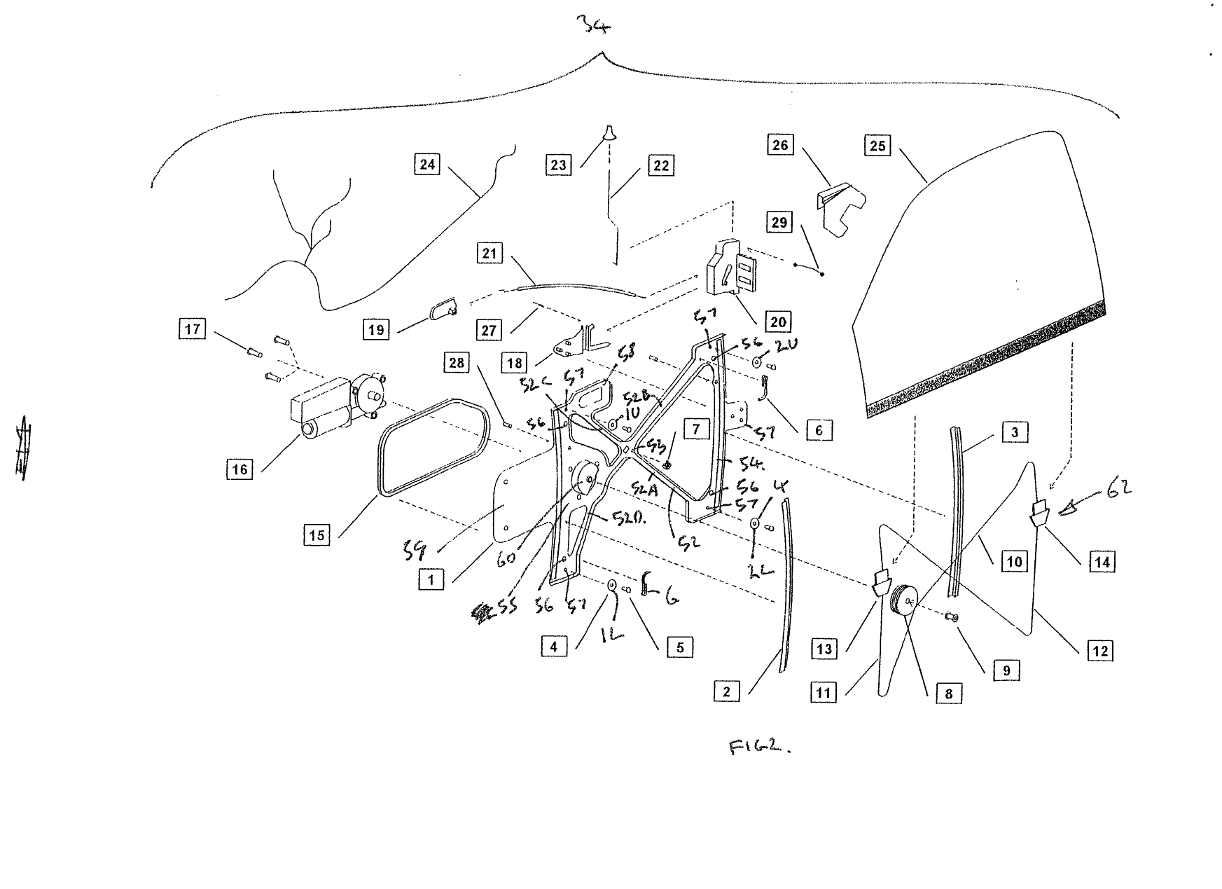

With reference to FIGS. 1 and 2, there is shown a door 30, in this case a front left hand door of a car (automobile). The door is assembled from various components including a door inner panel 31, a window regulator assembly 34, a combined anti intrusion beam and waist reinforcement beam component 36 and a door outer panel 38. The door outer panel 38 and door inner panel 31 together define a void within the door which is known as the “wet” side of the door.

Inner panel 31 is in the form of a pressing having an outer face 40 (“wet face”) which faces outwardly relative to an associated vehicle and an inner face 41 (“dry face”) which faces inwardly relative to an associated vehicle.

Door inner panel 31 includes an upper window frame 42 and a lower portion 43 which together define a window aperture 44. The door inner panel 31 includes various fixing holes 45 a window regulator motor aperture 46, a loud speaker aperture 47, latch fixing holes 48, holes 49 and inside door release handle 50. Typically, the inner panel will include reinforcement (not shown) adjacent to front hinge points and also in the region of the latch. A window regulator assembly 34, the components of which are shown in FIG. 2, is assembled as a subassembly and this subassembly is then assembled towards the outer face 40 of the door inner panel 31 in the direction of arrow A.

Consideration of FIG. 2 shows the components of the window regulator assembly in detail. A window regulator carrier 1 is provided as a chassis or frame on which is mounted further components of the window regulator assembly. The carrier 1 is in the form of a pressing and includes a ‘X’ shaped portion having arms 52A, 52B, 52C and 52D which meet at a central region 53. Ends of arms 52A and 52B remote from central region 53 are connected by a substantially vertical portion 54 of the carrier 1. Similarly, ends of arms 52C and 52D remote from the central region 53 are also connected by a substantially vertical portion 55.

Arms 52A, 52B, 52C and 52D are all generally elongate and U shaped in cross section as a result of the pressing process.

Carrier 1 includes holes 56 for mounting of the carrier, via fixing means which pass through hole 56 and through corresponding holes 45.

Carrier 1 further includes holes 57 for mounting of cable guides in the form of pulley wheels 4 via rivets 5.

Carrier 1 further includes mounting plate 57 upon which is mounted flexible latch support 18, mounting plate 58 upon which is mounted inner release handle assembly 19, and window regulator drive means plate in the form of a window regulator motor plate 59.

Motor plate 59 is generally planar in shape and is larger than window regulator motor aperture 46 so that seal 15 can provide for a moisture barrier between the interior of the door and the interior of the vehicle.

It can be seen that seal 15 is a parametric seal i.e. a perimeter like seal. In particular, seal 15 defines a boundary which is of similar shape to but slightly larger than the edge of aperture 46, and also is of similar shape to but slightly smaller than the edge of motor plate 59. When assembled, it can be seen that the seal 15 sits on the wet side of door inner panel 31 but on the dry side of motor plate 59. Furthermore, the seal 15 and door aperture 46 are both large enough to allow the passage of the motor 16 during assembly of the window regulator assembly onto the door inner panel.

Furthermore, it can be seen that all four cable guides are outside of the boundaries defined by seal 15 (no embodiments should this not be the case)

Motor plate 59 includes a cable drum housing 60.

Front rail 2 and rear rail 3 are mountable in spaced generally parallel relationship on portions 55 and 56 of carrier 1 respectively and guide cursors 13 and 14.

In further embodiments, the front and rear rails could be integral with the carrier.

Two cable tensioner 6 and a bare cable separator 7 are also mounted on the carrier and will be further described below.

Window regulator motor 16 is mounted on motor plate 59 via fixing screws 17.

Latch assembly 20 is mounted on flexible latch support 18 which allows for slight adjustment in the position of latch assembly 20 relative to carrier 1 when the window regulator assembly is assembled into the door inner panel.

An inner release handle cable 21 connects inner release handle assembly 19 to latch assembly 20.

A sill button link rod 22 is connected to latch assembly 20 at one end and at another end is connected to a sill button 23.

An outer handle connection 29 operably connects the outer door handle with the latch assembly once the handle has been fitted.

A latch security shield 26 is provided above the latch assembly 20 to prevent unauthorised entry to the vehicle by the use of a ‘slim Jim’.

A wiring harness 24 connects various electrical components of the window regulator assembly to the main wire harness of the vehicle (not shown).

For convenience the four pulley wheels 4 have been labelled as a first upper (1U), a first lower (1L), a second upper (2U) and a second lower (2L).

A bare cable assembly 62 is provided and includes a lower cable 11 which connects cable drum 8 to the front cursor 13, an upper cable 10 which connects the cable drum 8 to the rear cursor 14, and an intermediate cable 12 which connects the front cursor 13 to the rear cursor 14.

One end of lower cable 11 is wound around the threaded exterior of drum 8 and secured thereto.

One end of cable drum 10 is also wound around a different portion of the threaded exterior of cable drum 10 and secured thereto.

Window glass assembly 25 includes fixings for securing the lower edge thereof to the front and rear cursors 13 and 14.

In use drum 8 is mounted on bush 9 in driving connection with motor 16.

Rotation of the drum 8 by the motor in one direction will cause lower cable 11 to be wound onto the drum and upper cable 10 wound off the drum causing cursors 13 and 14 and hence the window to lower.

Conversely, rotation of the drum in the opposite direction by the motor will cause upper cable 10 to be wound onto the drum and lower cable 11 to be wound off the drum resulting in raising of the window glass 25.

It can be seen that the upper cable 10, lower cable 11 and intermediate cable 12 define a cable path which runs between the various pulley wheels 4 and includes a first cable path portion connecting the first upper cable guide to the first lower cable guide, a second cable path portion connecting the second upper cable guide to the second lower cable guide, a first further cable path portion connecting the first upper cable guide to the second lower cable guide and a second further cable path portion connecting the first lower cable guide to the second upper cable guide. Note that the first and second cable path portions are substantially vertical and are substantially parallel to the front and rear rails 2 and 3 which define the direction of vertical movement of the window glass 25. Furthermore, the first farther portion and second further portion together form a ‘X’ shape. Note that the second further portion is defined by the portion of the lower cable 11 running between the first lower cable guide and the drum (but not around the drum) in combination with that portion of the upper cable 10 running between the second upper cable guide and the drum (though not around the drum).

In view of the fact that the cable arrangement is a bare cable arrangement, it is necessary to ensure a minimum level of tension in all cables 10, 11 and 12 to ensure that they remain in place on appropriate pulley wheels and cable drum. Depending upon where the window glass is positioned e.g. fully closed with the glass in engagement with the glass run, part open, or fully open with part of the window regulator assembly being engaged with a lower stop, then this determines the various tension levels within the cables 10, 11 and 12, together with the two tensioner springs 6. In view of the fact that arms 52A, 52B, 52C and 52D extend to at least the mounting point of the pulley wheels 4 as do portions 54 and 55, then the carrier forms a triangulated structure at each of the pulley wheels where the tension in the cables 10, 11 and 12 is reacted.

In view of the fact that the first further and second further cable path portions cross and farther in view of the fact that as cable drum 8 rotates and that portion of cable 10 which is being wound onto or off from the cable drum moves laterally relative to the door then it can be seen that advantageously a bare cable separator 7 can be mounted at the central region 3 of the carrier 1 in order to guide cable 10 past cable 12 to ensure that they do not ‘saw’ against each during to the raising and lowering of the window glass 5.

The components as shown in FIG. 2 can all be pre assembled to form the window regulator assembly 34.

Component 36 is formed as a single pressing and includes an anti intrusion beam 64 designed to prevent intrusion into the vehicle of parts of other vehicles and the like in the event of a road traffic accident.

The component 36 farther includes a waist level reinforcement beam which in use supports the upper edge 38A of door outer panel 38 the other edges of door outer panel 38 being supported by the door inner panel.

The component 36 includes fixing holes 65 which co-operate with holes 49 and fixings 66 to secure the component 36 to the inner panel 31.

One method of assembling the door 30 is as follows:

Inner panel 31 is placed horizontally on a jig such that inner face 41 faces downwards and outer face 40 faces upwards (through the door need not be assembled ‘horizontally’).

The inner waist line seal 69 and glass run 70 are moved to position (see arrows B and C) and secured on the door inner panel 31 at the periphery of the window aperture 44.

Loudspeaker 71 is moved to position (see arrow D) and is secured to the door inner panel 31 by four screws 72 which are tightened by the assembly operator from above i.e. in a direction facing the outer face 40 (when on the jig faces upwards).

The window regulator assembly 34 is then moved to position in the direction of arrow A and secured in place by screws (not shown) which are screwed into holes 45 from above. The component 36 is then moved to position in the direction of arrow E and fixings 66 are used to secure it to the door inner panel (as described above).

Outer waist line seal 73 is mounted on upper edge 38A of outer panel 38 and this subassembly is then moved in the direction of arrow F and is secured to the door inner panel 31.

In particular, it should be noted that the various components of the door are assembled from the outside and this is contrary to known assembly methods where such components are assembled into the door from the inside.

It should also be noted that in view of the motor plate 59 and seal 15, the motor 16 is on the ‘dry’ side of the door since any moisture or rain entering the lowering portion 43 of the door via the outer waist line seal 73 is prevented from progressing through aperture 46 by seal 15.

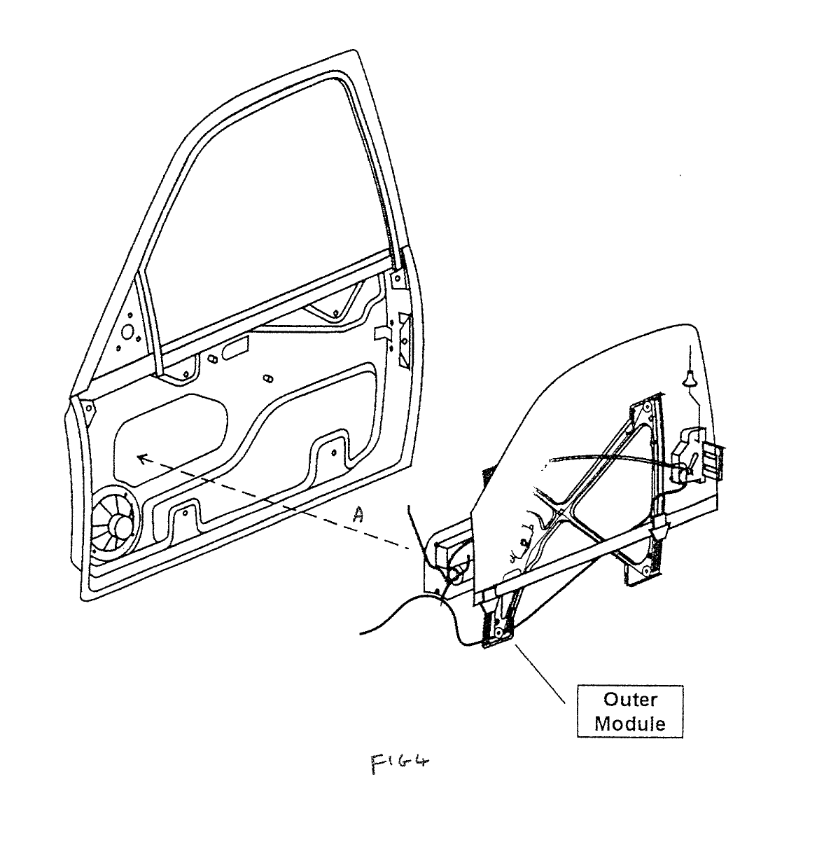

FIGS. 4 to 6 show the manner in which the door is assembled.

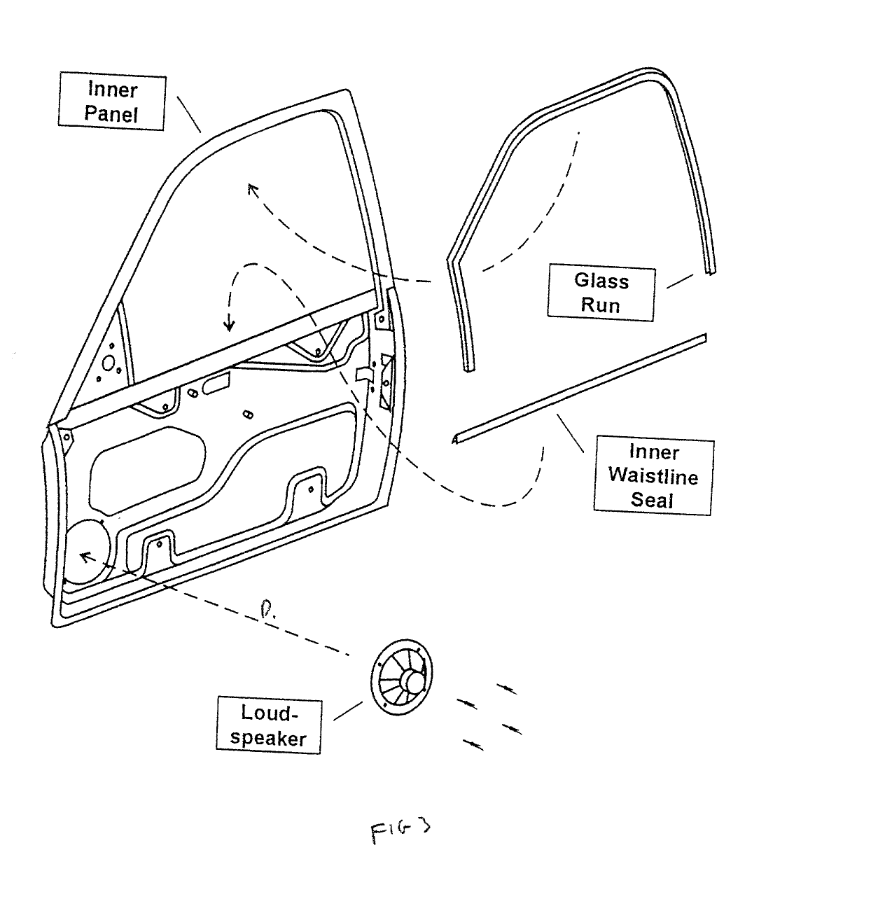

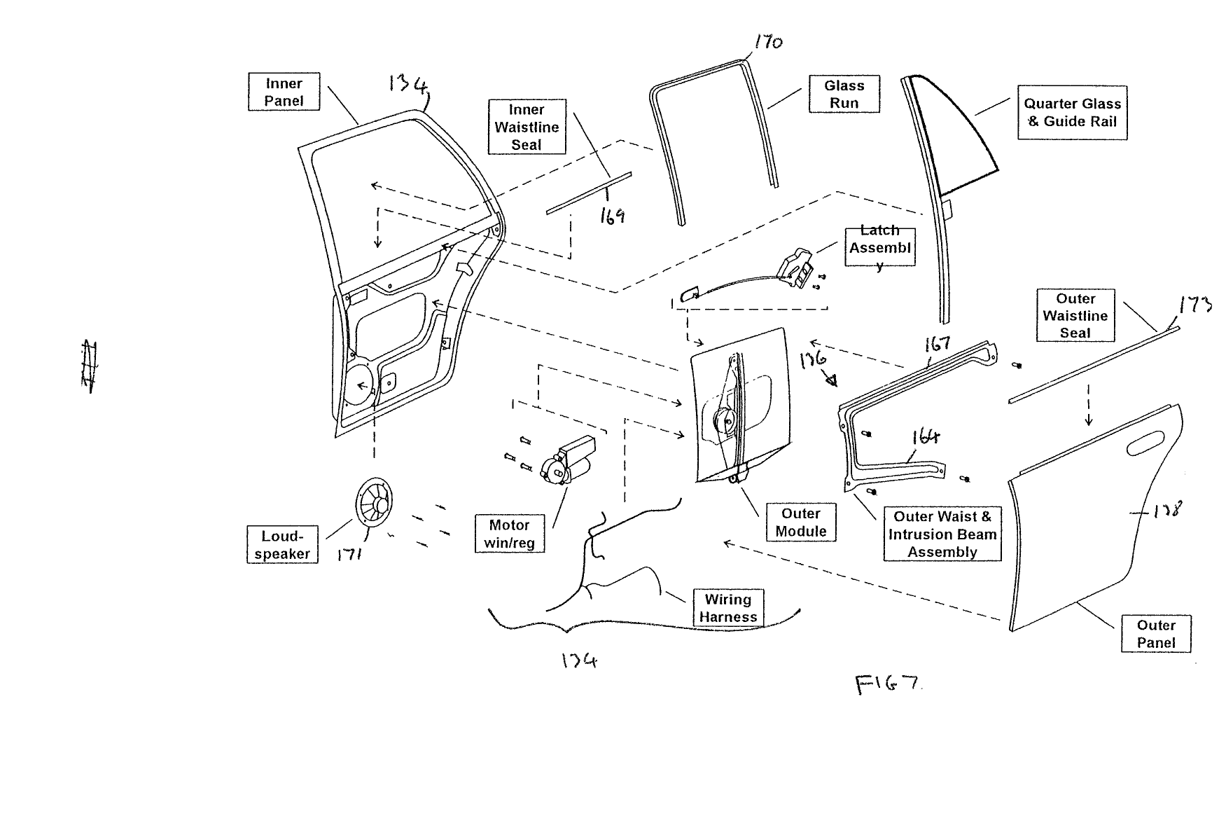

FIG. 7 shows a further embodiment of a vehicle door made according to the present invention, in which articles which perform substantially the same function as those in FIGS. 1 to 6 are labelled 100 greater.

In particular, this embodiment shows a rear vehicle door

Various fixings can be used to secure the various components.

Bolts and screws and other similar threaded fasteners have an assembled axis e.g. the longitudinal axis of the bolt or screw. Furthermore, they have an assembly direction defined by the bolt head or screw head. Thus, the assembly direction of a screw is from the screw head to the screw point. Thus, where such fixings are used, the assembly direction can be towards the outer face 40 i.e. inwardly relative to the associated vehicle.

Typically, known vehicle doors include fixings having assembly directions which are orientated outwardly relative to the vehicle.

In particular bolts and screws are releasable fixing means.

An alternative fixing means which can be used is a pop rivet which also has an assembly axis and an assembly direction.

Alternative fixing means include adhesive bonding of one component to another or alternatively welding of one component to another.

Furthermore, a known method of securing an outer panel to an inner panel is to ‘hem’ the edge of the outer panel i.e. to deform it around the corresponding edge of the inner panel.

It should be noted that bolts and screws are generally removable so that components being secured by the bolts or screws can be separated without damage to either component. Furthermore, pop rivets can be drilled out in order to separate two components again without damage to either component.

Depending upon the design, the adhesive bond between two components can be broken without damage to either component.

However, welding of one component to another component provides a fixing means which prevents the components being separated without damage to one or other component Furthermore, where components are welded together, such welding techniques generate extreme amounts of heat and hence this is not a fixing technique which is suitable for refixing a component within a partially assembled door.

Similarly, where an outer panel has been hemmed onto an inner panel, it is not possible to break the hemmed joint without damaging the outer panel such that it can no longer be reused. Advantageously, the fixing means used to secure the various door components allows the various door components to be non destructively separated and also reconnected.

It should be noted that the non destructive separating of components as mentioned herein refers to the non destruction of the components per se and not to be the non destruction of the fixing means. Thus, components fixed by an adhesive joint can be non destructively separated without damage to either component whilst nevertheless destroying the adhesive per se. Under these circumstances new adhesive has to be used to reconnect the two components.

Where the door 30 has been assembled using non destructive type fixing means then it is possible to:

a) remove a damaged outer panel and replace with a new outer panel,

b) remove both a damaged outer panel and a damaged component 36 and replace with a new component 36 and new outer panel,

c) remove an undamaged outer panel and remove an undamaged component 36 in order to gain access and repair other components of the door such as the window regulator assembly (and in particular replace a broken window glass), replace a damaged loudspeaker, or replace a damaged latch.

In further embodiments, the component 36 can be formed as a subassembly from an anti intrusion beam and a waist level reinforcement beam. As such in the event that just the anti intrusion beam is damaged then it can be replaced independently of the waist level reinforcement beam and vice versa.

It should be noted that loudspeaker 71 is secured by dedicated screws 72, that as to say screw 72 secure only loudspeaker 71. Similarly, component 36 is secured by dedicated fixings 66. Similarly, window regulator assembly 34 is also secured by dedicated screws (not shown).

In further embodiments, a particular fixing means may be utilized to secure two components. Thus, for example, where the space between the aperture 46 and the aperture 47 is a limited, a loud speaker could be secured by three of the four screws 72 with the fourth screw being utilized to secure both the part of the window regulator assembly 34 and a part of the loud speaker 71. Thus it can be seen that, depending upon the embodiment, various components can be assembled into place, whilst not being fully secured in place. The full securement in place only being possible once a further component has been added.

Furthermore, such a subassembly or component 36 can form part of a subassembly with the door outer panel.

A car manufacturer is typically supplied with various car components by component suppliers. The components themselves can be individual items (such as nuts or bolts) or, alternatively, they can be subassemblies such as engines, gearboxes, axles, bonnets (hoods), boot lids (trunk lids), body shells or doors.

With regards to body shells, hoods, trunks and doors, it is important that the exterior surfaces of these components, of a particular vehicle are all painted with paint from the same batch, in order to avoid slight variations in color.

Clearly, the major exterior colored surface of the door 30 is the exterior surface of the door outer panel 38. It is possible to paint the exterior surface of the upper window frame in a neutral color, such a black, without significantly affecting the exterior aesthetic appearance of the vehicle as a whole. Thus, an alternative method of assembling the door is as follows.

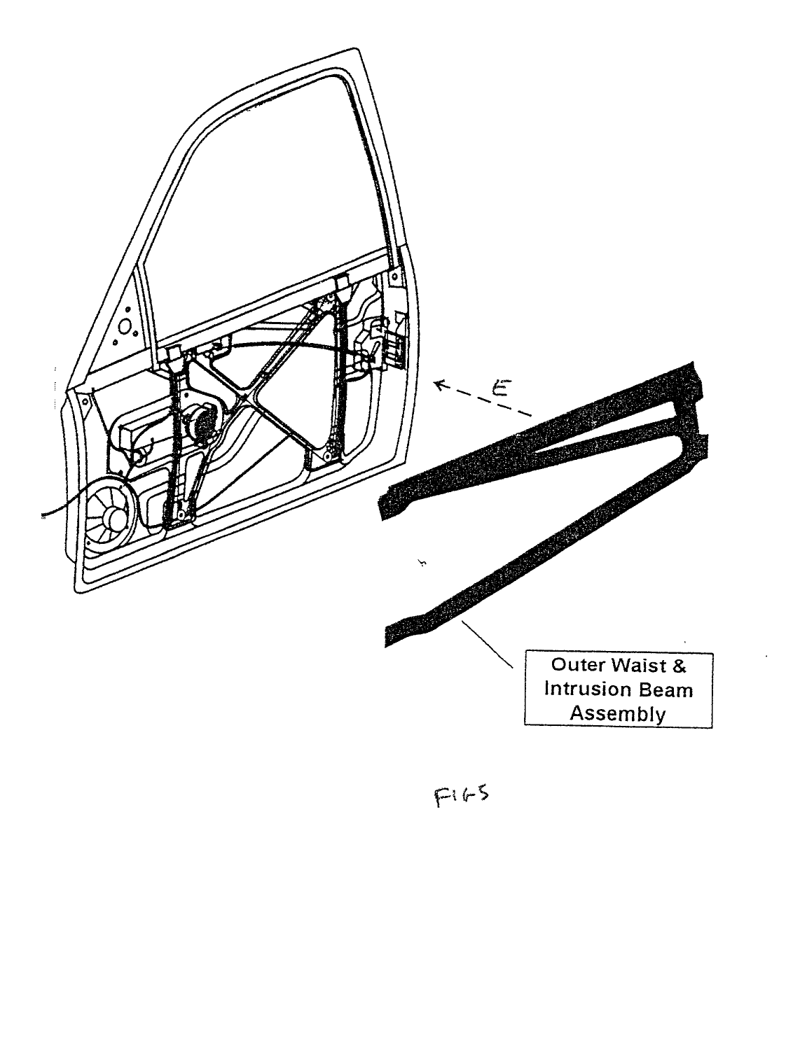

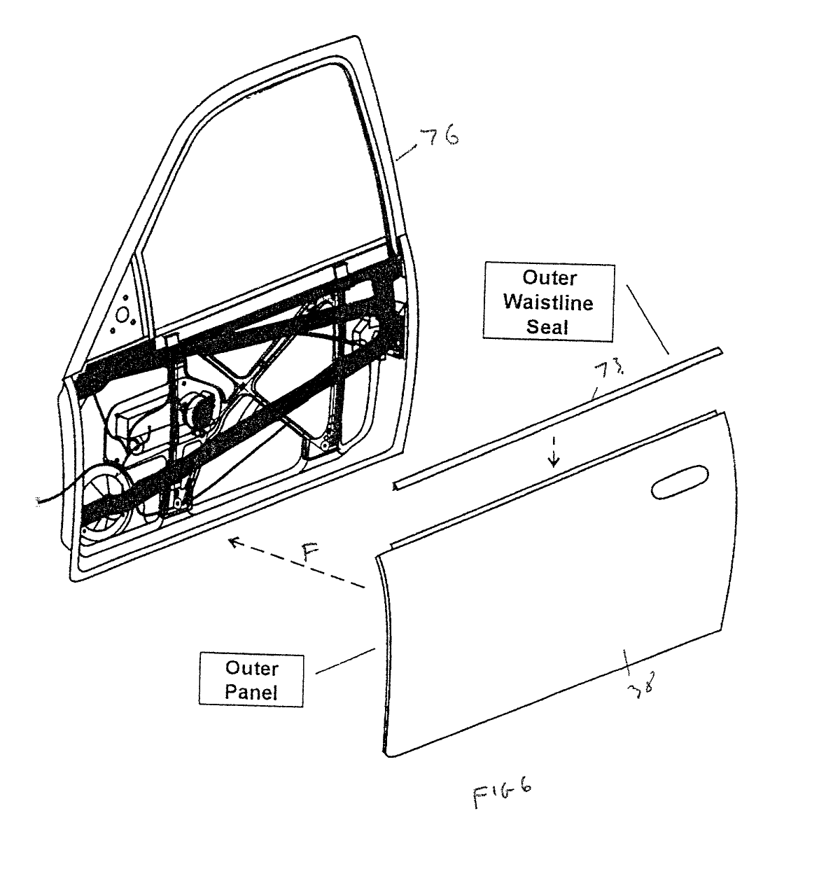

All of those components as shown in FIG. 5 can be assembled together to form a door subassembly 76 (see FIG. 6) this can be carried out at a door manufacturers assembly line (also known herein as a first assembly line).

The door outer panel can be provided at the car manufacturers assembly line (also known herein as a second assembly line) wherein it can be allocated to a specific car body shell along with other doors and a hood and trunk. This set of components can then all be painted simultaneously with paint from the same batch to ensure uniform color.

The door assembly 76 can then be transported from the door assembly line to the vehicle assembly line where the outer panel can be assembled onto the door and the door can be assembled onto the associated vehicle. Note that the order in which the door outer skin is assembled on to the door and the door is assembled onto the associated vehicle can be carried out in either order.

Note that the door assembly 76 can have various levels of equipment e.g. with or without loudspeaker, with a window regulator motor or with a manual window regulator winder, with a manual only latch arrangement or with a electronic central door locking latch arrangement.

Furthermore, there may be several different types of door outer panel at the vehicle assembly line most notably outer panels of differing color e.g. red, green and blue but also outer panels of differing shapes for fitment onto different car models having a substantially common floor pan.

Furthermore, there may be several different inner trim panels at the car assembly plant. Thus by way of example if there are three different door subassemblies 76, four different outer panels 38 and five different inner trims panels, these can be 60 different door types (i.e., 3×4×5=60). It can be seen that where a door manufacturer has a first assembly line and a car manufacturer has a second assembly line the door manufacturer only has to supply three different types of doors to the car manufacturers assembly line. This has significant logistic advantages.

The aforementioned description is exemplary rather that limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise than as specifically described. For this reason the following claims should be studied to determine the true scope and content of this invention.

1. A window regulator assembly for assembly into a vehicle comprising:
a carrier having a first and second guide rail in a spaced generally parallel relationship;
a first and a second upper cable guides being mounted on the carrier proximate the upper ends of the first and second guide rails respectively; and
a first and a second lower cable guides being mounted on the carrier proximate the lower ends of the first and second guide rails respectively with a cable path being defined between the first upper, second upper, first lower and second lower cable guides by a bare cable arrangement, the cable path having at least a first portion connecting the first upper cable guide to the first lower guide, a second portion connecting the second upper guide to the second lower cable, and a first further portion connecting one of the first upper and lower cable guides to one of the second upper and lower cable guides, the bare cable arrangement being drivable in use by a drive means, with a first and second cursor being connected to the bare cable arrangement so as to provide a double lift bare cable window regulator assembly.

2. A window regulator assembly as defined in claim 1 in which the first further portion of cable path connects the first upper cable guide to the second lower cable guide.

3. A window regulator assembly as defined in claim 1 in which the cable path includes a second further portion connecting the second upper cable guide to the first lower cable guide.

4. A window regulator assembly as defined in claim 1 in which the carrier includes an elongate portion laying substantially parallel and adjacent to part of the cable path.

5. A window regulator assembly as defined in claim 1 in which the carrier includes an elongate portion laying substantially parallel and adjacent to the first or second portions of the cable path.

6. A window regulator assembly as defined in claim 1 in which the carrier includes an elongate portion laying substantially parallel and adjacent to the first or second further portion of the cable path.

7. A window regulator assembly as defined in claim 1 in which the cable path includes a first drive portion connecting the drive means to at least one of the first upper, second upper, first lower or second lower cable guides, and the carrier includes an elongate portion laying substantially parallel and adjacent to the first drive portion of the cable path.

8. A window regulator assembly as defined in claim 7 in which the cable path includes a second drive portion connecting the drive means to another of the first upper, second upper, first lower or second lower cable guides and the carrier includes an elongate portion laying substantially parallel and adjacent to the second drive portion of the cable path.

9. A window regulator assembly as defined in claim 4 in which said elongate portion extends at least to one of the first upper, second upper, first lower, or second lower cable guides.

10. A window regulator assembly as defined in claim 4 in which said elongate portion is generally U shaped in cross section.

11. A window regulator assembly as defined in claim 1 in which the carrier includes a generally ‘X’ shaped portion, with arms of the ‘X’ laying parallel and adjacent to portions of the cable path.

12. A window regulator assembly as defined in claim 11 in which the generally ‘X’ shaped portion connects portions of the carrier laying parallel and adjacent to the first and second guide rails.

13. A window regulator assembly as defined in claim 1 in which the carrier includes mountings for at least one functional component of a door.

14. A window regulator assembly as defined in claim 1 in which the drive means is mounted on a plate of the carrier, the plate having a sealing surface for sealing against a “wet” side of an associated door inner panel.

15. A window regulator assembly as defined in claim 14 in which the drive means is mounted on an inside (“dry”) surface of the plate when considering an associated vehicle.

16. A window regulator as defined in claim 14 in which at least one cable guide is mounted outside of a boundary defined by the sealing surface.

17. A window regulator assembly as defined in claim 16 in which a plurality of cable guides are mounted outside of a boundary as defined by the sealing surface.

18. A window regulator assembly as defined in claim 1 further including a window glass.

19. A door including a window regulator assembly as defined in claim 1, the vehicle door including a door inner panel having an aperture which allows the passage of the drive means during assembly of the window regulator assembly onto the door.
